(19) United States
(12) Patent Application Publication
(10) Pub. No.: US 2017/0310098 A1
(43) Pub. Date: Oct. 26, 2017

(54) Surge Voltage Protection Circuit for Direct Line Operated Induction Heaters and Method of Operation

(71) Applicant: David R. Pacholok, Sleepy Hollow, IL (US)

(72) Inventor: David R. Pacholok, Sleepy Hollow, IL (US)

(21) Appl. No.: 15/133,899

(22) Filed: Apr. 20, 2016

(51) Int. Cl. H02H 3/20; H05B 6/02

(52) U.S. Cl. CPC H02H 3/20; H05B 6/02

(57) ABSTRACT

An apparatus and method for greatly increasing power line surge/transient resistance of power semiconductors in inductive heating equipment, in which a sample of the instantaneous line voltage or its rectified equivalent is applied to a comparator input terminal, and a reference voltage corresponding to a predetermined surge shutdown voltage is applied to an opposite comparator input, such that comparator output changes state in response to the predetermined surge shutdown voltage, and is functionally connected to gate drive circuitry to disable gate drive circuitry for the duration of the surge/transient.

### FIELD OF THE INVENTION

The present invention relates to a method and circuit for surge voltage protection for direct line operated small hand held induction heaters of less than 10 KW where high frequency inverters are powered from rectified but unfiltered raw A.C. line voltage.

### PRIOR ART

In such small induction heaters where high frequency inverters are powered from rectified but unfiltered raw A.C. line voltage, large (typically electrolytic) bulk filter capacitors are not utilized to reduce the ripple that occurs at twice the power line frequency, i.e., 100 or 120 Hz. The use of such capacitors following the rectifier to smooth the voltage applied to the high frequency inverter is not preferred for three reasons:
1. The low power factor that results (typically 0.6) limits the power available from the A.C. line power source to the line current capability x line voltage x power factor.
2. The odd order harmonic currents (3^{rd}, 5^{th}, 7^{th} etc.) generated by a capacitor input rectifier/filter are limited by regulations in many countries. In the E.U., for example, the regulation IEC61000-3-2 limits odd order line harmonic currents to levels that preclude the use of a rectifier followed by a capacitor of several 100's to 1000's of microfarads.
3. The bulk filter capacitors are expensive, large, and heavy. This makes their use in small, self-contained hand-held induction heaters virtually impossible.

Bulk filter capacitors of large value do, however, greatly improve the resistance of high frequency inverters to some power line surges. Such surges can raise the nominal 240 VAC (E.U.) line voltage to 400 VAC or more for a period of 100's of microseconds to several seconds, leading to destruction of the power semiconductors in the high frequency inverter. Surges that last less than one-half of an A.C. cycle, that is in the 100 microsecond to 10 millisecond range, are far more common than surges lasting seconds, and are sometimes called transients. Surges and transients are very common in developing countries such as India, China, Brazil, etc. Electrolytic capacitors are quite effective in limiting the shorter surges by absorbing their energy in the form of E_{cap}=½CV². For longer surges their effectiveness rapidly diminishes.

Metal oxide varistors (MOV's) are typically used to suppress short transients, but are nearly useless in preventing inverter damage from surges, as their clamping voltage may be two or more times the peak of the normal sine wave voltage. Such clamped surges are capable of damaging the high frequency inverter semiconductors.

### SUMMARY OF INVENTION

It is an object of this invention to provide circuitry for greatly increasing the resistance of high frequency inverters in small hand held induction heater equipment of less than 10 KW where high frequency inverters are powered from rectified but unfiltered raw A.C. line voltage, to long transients and all surges. This is accomplished by the circuitry wherein the method of disabling the inverter drive electronics within a few microseconds of the beginning of a transient or surge, and re-enabling the inverter drive electronics when the surge or transient has subsided to a safe voltage level.

### BRIEF DESCRIPTION OF THE DRAWINGS

FIG. 1 presents a circuit diagram of a prior art series resonant, ZIS circuit used in hand held induction heaters.

FIG. 2 presents a circuit diagram of a prior art resonant flyback circuit used in hand held induction heaters.

FIG. 3 presents a circuit diagram of a prior art Edwards or current fed ZVS sine wave converter circuit used in hand held induction heaters.

FIG. 4 presents a general circuit diagram incorporating a surge/transient suppression circuit for shutting down any induction heater gate inverter drive in response to an overvoltage condition.

FIG. 5 presents a simple circuit diagram of one preferred embodiment of a circuit for use in small hand held induction heaters of less than 10 KW incorporating the surge/transient suppression circuit of the present invention.

### DESCRIPTION OF INVENTION

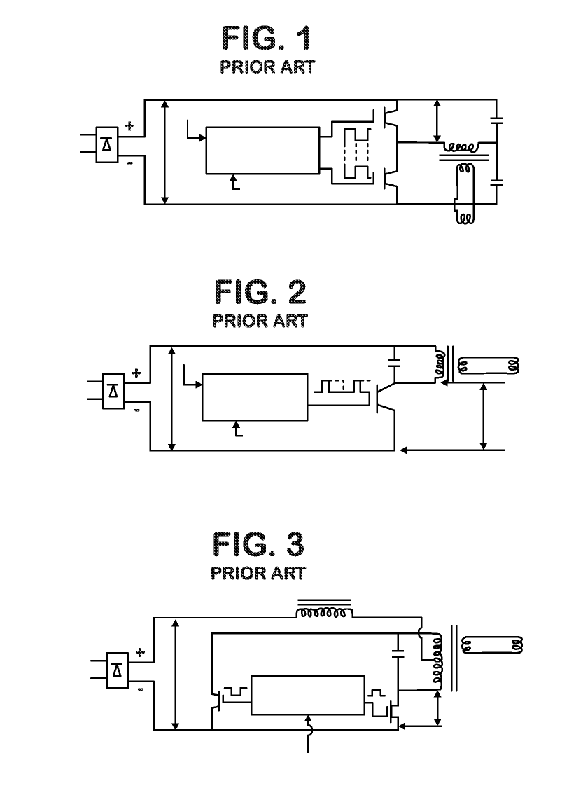

Three basic types of inverter circuitry are presently used in small, line operated induction heaters: series resonant inverter ZIS circuits as illustrated in FIG. 1; resonant “flyback” circuits as illustrated in FIG. 2 and Edwards or current-fed ZVS sine wave converter circuits as illustrated in FIG. 3.

It will be understood by those skilled in the art that there is a difference of at least 2 in the peak voltage stress applied to the semiconductor power switches of prior art circuits of FIGS. 1, 2 and 3, depending upon whether gate drive to the power switches is activated or deactivated.

In the circuit of FIG. 1, during operation, either switch illustrated is off at any given moment, with its opposite being on. Therefore, the full voltage stress, V_{DC} is applied alternately to each. By removing gate drive to both switches, they are both off. The V_{DC} (including any surge) is now equally divided between both as in any series circuit having two identical elements; (twice the surge voltage withstood).

In the circuit of FIG. 2, the resonant flyback, any applied VDC including a surge is multiplied by a factor of 2.5-4.5 by normal circuit operation. This class of inverter is often current mode controlled, limiting the energy E=½LI² in the combined inductance of the isolation transformer and work coil. This will not provide surge protection because the flyback voltage across Cᵣₑₛ adds to V_{DC} to raise Vsw, beyond what is achieved by simply disabling switch gate drive during a transient or surge. (2.5-4.5 times surge volt withstood with no damage) In the case of circuit 3, the Edwards or current-fed ZVS sine wave converter, the peak switch voltage is π times V_{DC}, including any surge. Shutting the gate drive off to switch 1 and switch 2 reduces the surge voltage stress on switch 1 and switch 2 by a factor of π or 3.14. (3.14 times surge voltage now withstood, with no damage} Full bridge versions of half bridge circuits and push-pull circuits also exist, and are used at higher power levels. The same levels of surge switch voltage reduction apply to these as well.

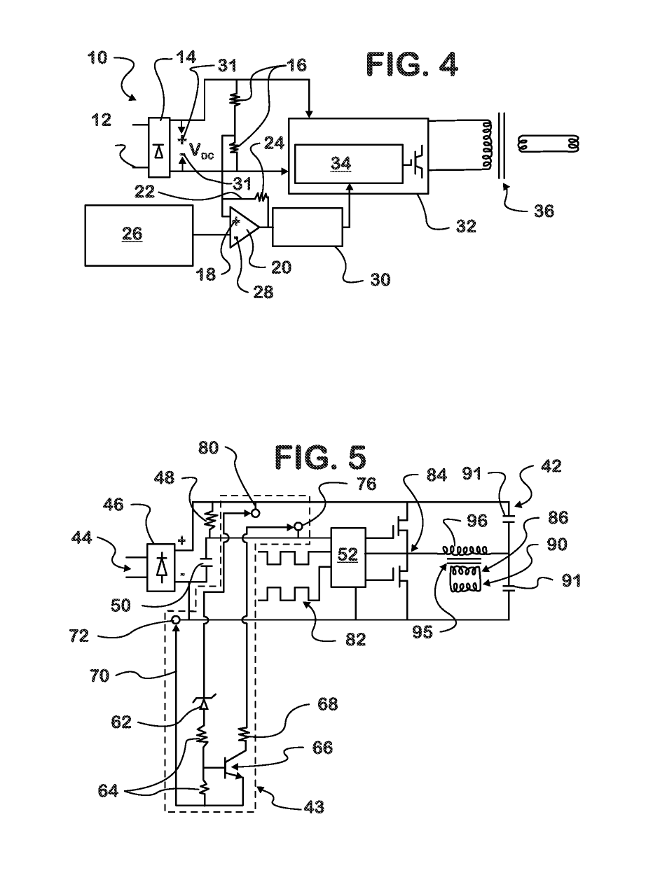

FIG. 4 depicts the general method of shutting down any induction heater gate drive in response to an over voltage. A voltage divider 16 reduces the several 100's of D.C. volts from the rectifier 12 to several volts for convenient processing by low-level analog circuitry. When the voltage divider voltage 22 or 18 exceeds the surge shutdown reference voltage 26, the comparator 20 output goes from low to high, disabling the drive electronics 34, by way of one shot timer 30, if used. If desired, a hysteresis resistor 24 at the comparator 20 output to the positive input of hysteresis resistor 24 may be added to provide positive switching action in a high noise electrical environment. A one-shot or monostable multivibrator 30 may be employed to keep the inverter disabled a prescribed time after the transient or surge terminates. The surge voltage may be sensed at the A.C. terminals 12 instead of D.C. terminals 31 following rectification, but this requires bipolar voltage sensing, and some isolation means such as an optoisolator to feed the disable signal to the drive electronics, and is not preferred due to complexity.

As illustrated, the circuit 10 of FIG. 4 includes AC line voltage input 12 which feeds rectifier 14 to convert AC to high voltage DC. Voltage divider resistors 16 provide a proportional sample of the high DC voltage value to a positive input 18 of comparator 20. Comparator 20 trip point occurs when compared to the surge shutdown reference voltage 26, fed to a negative input 28 of the comparator 20. Output from the comparator 20 is fed to a one shot multivibrator 30, if used, and drives the inverter gate drive disable input for inverter 32 when the surge exceeds a predetermined level set by surge reference voltage 26.

FIG. 5 shows a surge protected half-bridge series resonant inductive heater circuit 42. The surge protection circuit 43 thereof comprises only 5 components, as outlined in phantom, may be applied with equal ease to the prior art circuits of FIGS. 1-3. As illustrated, inductive heater circuit 42 of FIG. 5 includes an AC line voltage input 44 which feeds a rectifier 46 which converts AC to high voltage DC. Resistor 48 and capacitor 50 form a low voltage power supply providing power to the inverter gate drive circuit 52. The surge protection circuit 43 incorporated into the main circuit of FIG. 5 comprises Zener diode 62, resistor divider 64, transistor 66, and limiting resistor 68, which connect to the exemplary primary circuit 42 to create the surge protected circuit 42. The bottom horizontal COM arrow 70 connects to COM connection 72. The Zener diode 62 connects to V_{Dc} connection 80, and the limiting resistor 68 connects to low voltage power supply connection 76.

It will be understood that the Zener diode 62 along with the resistor divider 64 and the transistor 66 form a voltage comparator. When the positive rail of the high voltage DC supply rises to the point where the Zener diode 62 conducts, the transistor 66 turns on, disabling the inverter 52.

The two square wave symbols 82 seen represent the drive signals for the inverter 52 logic. The inverter gate drive circuit 52 drives a half-bridge MOSFET power switch 84, converting high voltage DC to high voltage, high frequency AC. High frequency transformer 95 converts high voltage, high frequency AC to low voltage, high current, high frequency AC which is fed to work coil 90.

Two half-bridge capacitors 91 provide resonant action along with inductance reflected to primary 96. The transformer primary 96 is horizontal between the two half-bridge MOSFET power switches 84 and the capacitors 91. The secondary 86 of the transformer 95 is connected to the work coil 90.

As those skilled in the art would comprehend, a 400V Zener diode 62 serves as the reference surge shut-down voltage, while transistor 66 acts in place of a comparator. Lower resistor 64 bypasses collector to base leakage current, while resistor 68 damps the resonant action of 50 and stray circuit inductance, preventing voltage ringing/reversal across 50, which could damage gate drive electronics I.C., an IR 2214. In this circuit a delay in re-enablement of operation following a transient occurs because 50 must charge from near zero volts to the start up threshold voltage of drive electronics I.C. IR2214. This time may be calculated by rearranging:

$$I = C dV \text{/} dT to dT = C \text{/} I dV and substituting , \\ I = V \text{/} R = \frac{240 - 5}{25 \text{,} 000} = 0.1 A$$

$$C = capacitor 50 = .47 μ F$$

$$dV = approximately 10 V \text{(} start up threshold of IR 2214 \text{:}$$

$$dT = \frac{4.7 E - 7}{1 E - 2} ( 1.0 E 1 ) = .00047 seconds$$

This delay functions equivalently to that of the one shot multivibrator of FIG. 4. The circuit of FIG. 5 was tested to destruction with and without the surge protection circuit 43. A 100 μsec transient with a peak voltage of 680 volts destroyed the 600V FET switches without the surge protection circuit 43. With the surge protection circuit 43 in place, circuit destruction potential rose to 1240 volts. The A.C. line voltage was raised above the nominal 240 VAC to simulate a sustained over voltage surge. Without the surge protector circuit 43 being incorporated, the power circuit failed at 350 VAC RMS. In contrast, the surge protection circuit 43 shut the inverter 52 off at 292 VAC RMS. After a few seconds, overheat of Zener diode 62 and top resistor of voltage divider 64, were noted. It will also be understood that a PTC resistor (not shown) may be substituted for this top resistor of voltage divider 64 to prevent overheat.

It will be understood by those skilled in the art that the protection circuit 43 provides a number of advantages, some of which have been described above and others of which are inherent in the invention. Also, modifications may be proposed without departing from the teachings herein. Accordingly the scope of the invention is only to be limited as necessitated by the accompanying claims.

1. A method for greatly increasing A.C. power line voltage surge or transient resistance of power semiconductors in rectifier supplied induction heating units in which a surge or transient is detected and wherein a gate drive to power semiconductor switches is disabled by applying a sample of the instantaneous line voltage or its rectified equivalent to a comparator input terminal, and a reference voltage corresponding to a predetermined surge shutdown voltage is applied to an opposite comparator input, such that comparator output changes state in response to the predetermined surge shutdown voltage, and is functionally connected to gate drive circuitry to disable gate drive for the duration of the surge/transient, rendering such switches non conductive in the forward direction for the duration of the surge or transient.

2. The method according to claim 1, in which the gate drive continues to be disabled for a short period of time after the end of the transient, allowing the A.C. power line voltage to drop to normal levels.

3. The method according to claim 1, in which the gate drive is disabled at a predetermined level of A.C. power line over-voltage and re-enabled at a predetermined lower level of A.C. power line voltage.

4. The method according to claim 3, in which the gate drive is restricted at a lower A.C. line voltage such as occurs within 20 degrees of the A.C. power line zero voltage crossing.

5. The method according to claim 1 wherein the surge shutdown voltage is approximately equal to: nominal A.C. line voltage x (√2)×1.2.

6. An apparatus for greatly increasing power line surge/transient resistance of power semiconductors in inductive heating equipment, in which a sample of the instantaneous line voltage or its rectified equivalent is applied to a comparator input terminal, and a reference voltage corresponding to a predetermined surge shutdown voltage is applied to an opposite comparator input, such that comparator output changes state in response to the predetermined surge shutdown voltage, and is functionally connected to gate drive circuitry to disable gate drive for the duration of the surge/transient.

7. The apparatus according to claim 6, in which the gate drive continues to be disabled for a short period of time after the end of the transient, allowing A.C. line voltage to drop to normal levels.

8. The apparatus according to claim 7, in which the gate drive is disabled at a predetermined level of A.C. power line over voltage and restarted at a somewhat lower predetermined level of A.C. power line voltage.

9. The apparatus according to claim 6, in which the voltage reference is a Zener diode.

10. The apparatus according to claim 6, in which the comparator is a simple bipolar junction or field effect transistor.

11. The apparatus according to claim 6, in which the surge shutdown voltage is approximately equal to: nominal A.C. line voltage x (√2)×1.2.

12. An apparatus for greatly increasing power line surge/transient resistance of power semiconductors in inductive heating equipment, in which a sample of the instantaneous line voltage or its rectified equivalent is applied to a comparator input terminal, and a reference voltage corresponding to a predetermined surge shutdown voltage is applied to an opposite comparator input, such that comparator output changes state in response to the predetermined surge shutdown voltage, and is functionally connected to gate drive circuitry to disable gate drive for the duration of the surge/transient, wherein the reactivation of the gate drive is delayed following a transient or surge event as calculated by: I=C dV/dT to dT=C/I dV.
